(19) United States
(12) Patent Application Publication
(10) Pub. No.: US 2008/0111529 A1
(43) Pub. Date: May 15, 2008

(54) METHODS, APPARATUS AND MEDIA FOR CONTROL SCHEME FOR PARALLEL HIGH-SIDE SWITCHING MOSFETS

(75) Inventors: Shreya Shah, Austin, TX (US); John J. Breen, Harker Heights, TX (US); Guangyong Zhu, Austin, TX (US)

Correspondence Address: ANDREA E. TRAN;PRAMUDJI WENDT & TRAN, LLP, 1800 BERING DRIVE, SUITE 540, HOUSTON, TX, 77057, US

(73) Assignee: Dell Products L.P., Round Rock, TX (US)

(21) Appl. No.: 11/558,444

(22) Filed: Nov. 10, 2006

(51) Int. Cl. G05F 1/10

(52) U.S. Cl. 323/283

(57) ABSTRACT

The present disclosure relates to a power regulator including an inductor and a high-side switch comprising a first MOSFET and a second MOSFET in parallel. The regulator may also include an electrical pathway between the high-side switch and the inductor. A controller may also be communicatively coupled to the high-side switch. The controller may comprise logic to operate the high-side switch by simultaneously enabling the first MOSFET and disabling the second MOSFET.

### BACKGROUND

1. Technical Field

The present disclosure relates to information handling systems, and more particularly, to power regulators.

2. Background Information

As the value and use of information continues to increase, individuals and businesses seek additional ways to process and store information. One option available to users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

MOSFETs (Metal Oxide Semiconductor Field Effect Transistors) have been used in power electronics applications since the early 1980's due to their appreciable current carrying and off-state voltage blocking capability with low on-state voltage drop. They have managed to replace bipolar junction transistors (BJTS) in many applications due to their simpler gate drive requirements and higher positive temperature coefficient that allow devices to be placed in parallel for higher current capabilities.

Power-regulators that are designed to deliver high output currents require more than one high-side switching MOSFET to cope with high thermal energies and avoid thermal shut down issues (e.g., events that occur due to unmanageable high thermal energy dissipation). Because MOSFETs have a positive temperature coefficient they can be placed in parallel without the need for source resistors. In contrast, BJTs may need small emitter resistors that provide negative feedback.

The parallel connection of MOSFETs allows higher load currents to be handled by sharing the current between the individual switches. In a power regulator, identical high-side (HS) MOSFETs switches are designed into the circuit in a parallel fashion, and both are enabled during operation and both are disabled when not in use.

Unfortunately, increasing the number of parallel high-side switching MOSFETs leads to an increase in losses which negatively impacts battery life when running in a light-load mode. A tight-load mode arises when the output current delivered by the power-regulator is drastically reduced. In the light-load mode, the additional parallel high-side switching MOSFET is unnecessary, as the thermals can be managed by a single MOSFET. The additional MOSFET, however, may be necessary some of the time. Unfortunately, at other times, the presence of an additional HS has no added benefit in the design, but rather only adds to the losses, making the power-regulator very inefficient and thus reducing battery life.

### SUMMARY

The following presents a general summary of some of the many possible embodiments of this disclosure in order to provide a basic understanding of this disclosure. This summary is not an extensive overview of all embodiments of this disclosure. This summary is not intended to identify key or critical elements of the disclosure or to delineate or otherwise limit the scope of the claims. The following summary merely presents some concepts of the disclosure in a general form as a prelude to the more detailed description that follows.

According to one non-limiting embodiment, a power regulator is disclosed. The regulator may include a high-side switch comprising a first MOSFET and a second MOSFET in parallel. The regulator may also include an inductor and an electrical pathway between the high-side switch and the inductor. The regulator may also include a controller communicatively coupled to the high-side switch, the controller comprising logic to operate the high-side switch by simultaneously enabling the first MOSFET and disabling the second MOSFET.

According to another non-limiting embodiment there is provided a method of regulating current flowing through an electrical pathway between a high-side switch and an inductor, wherein the high-side switch comprises a first MOSFET and a second MOSFET in parallel. The method includes operating the high-side switch by simultaneously enabling the first MOSFET and disabling the second MOSFET.

According to another embodiment there is provided a computer-readable medium having stored thereon executable instructions for performing a method for regulating current flowing through an electrical pathway between a high-side switch and an inductor. The high-side switch may comprise a first MOSFET and a second MOSFET in parallel. The medium may include at least one instruction for operating the high-side switch by simultaneously enabling the first MOSFET and disabling the second MOSFET.

### BRIEF DESCRIPTION OF THE DRAWINGS

The following drawing illustrates one of the many possible embodiments of this disclosure in order to provide a basic understanding of this disclosure. This drawing does not provide an extensive overview of all embodiments of this disclosure. This drawing is not intended to identify key or critical elements of the disclosure or to delineate or otherwise limit the scope of the claims. The following drawing merely presents some concepts of the disclosure in a general form. Thus, for a detailed understanding of this disclosure, reference should be made to the following detailed description, taken in conjunction with the accompanying drawing, in which like elements have been given tike numerals.

FIG. 1 is a schematic representation of a non-limiting embodiment of a power regulator.

### DETAILED DESCRIPTION

For purposes of this disclosure, an embodiment of an Information Handling System (IHS) may include any instrumentality or aggregate of instrumentalities operable to compute, classify, process, transmit, receive, retrieve, originate, switch, store, display, manifest, detect, record, reproduce handle, or utilize any form of information, intelligence or data for business, scientific, control, or other purposes. For example, an IHS may be a personal computer, a network storage device, or any other suitable device and may vary in size, shape, performance, functionality, and price. The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to transmit data communications between the various hardware components.

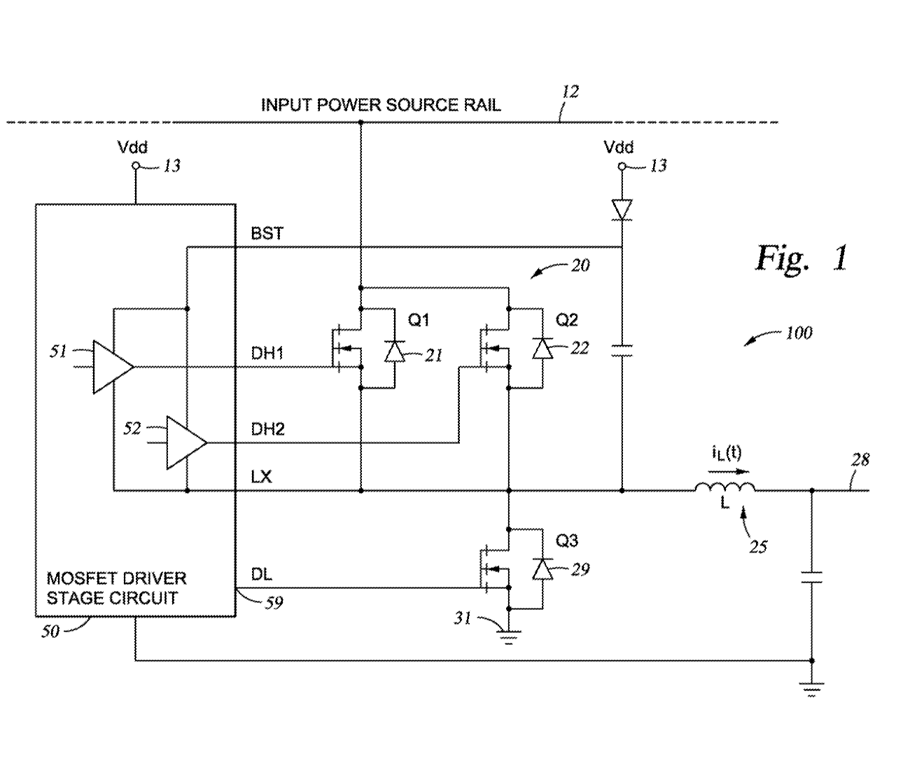

Referring now to FIG. 1, there is shown a schematic representation of a non-limiting embodiment of power regulator 100. In the embodiment as shown, power regulator 100 may take power of a certain voltage and step it down. The present disclosure may also be applied to a power regulator that takes power of a certain voltage and boosts it up to a desired constant voltage.

The power regulators of this disclosure are of the type generally known as switch mode power supply (SMPS). As such, the power regulators of this disclosure are considered electronic power supply units that may incorporate a switching regulator that is, an internal control circuit that switches the source current rapidly on and off, causing a charging and discharging of an inductor at a certain frequency, in order to stabilize the output.

The source current, or power to be regulated, may be input into power regulator 100 from any suitable power source. In some embodiments, it may be desirable for regulator 100 to allow for universal input, meaning it may accept power from most main supplies throughout the world, with rated frequencies from 50 Hz to 60 Hz and voltages from 100 V to 240 V (although a manual voltage “range” switch may be required). In other embodiments, the power regulator may operate from a much wider frequency range and often from a DC supply as well. In some embodiments, the input power to be regulated is rectified DC voltage.

In the non-limiting embodiment as shown, input power source rail 12 provides rectified DC power to regulator 100. While any suitable voltage may be utilized, input power source rail 12 will in some embodiments provide rectified DC power in the range of about 10V-30V, in other embodiments in the range of about 10V-20V, and in even other embodiments in the range of about 15V to about 20V.

Not to be confused with the power to be regulated by power regulator 100, operating power is also supplied to power regulator 100. In the embodiment as shown, operating power is provided by Vdd 13. Certainly, any suitable type of power arrangement as is known in the art may be utilized, and this present disclosure is not meant to be limited to any particular power arrangement for operational power. This operating power is generally the type of power utilized to power transistor logic. While any suitable operational power voltage may be utilized, in some embodiments, operational power will be in the range of about 3.5V to 5V.

According to FIG. 1, power regulator 100 may also include high-side switch 20. This high-side switch 20 may function as a switch to control the flow of power from input power source rail 12.

High-side switch 20 may comprise N number of MOSFETS arranged in parallel. High-side switch 20 will comprise at least 2 MOSFETS arranged in parallel, and may include more MOSFETs arranged in parallel if necessary for the particular end use application. It is noted that while there must be at least 2 MOSFETS arranged in parallel, the present disclosure is not to be limited to any particular number of MOSFETS, with N only limited by the particular design requirements of the desired end use. In the non-limiting embodiment shown, N is 2 as high-side switch 20 is shown having MOSFET 21 and MOSFET 22, but it should be understood that N in various other embodiments contemplated may range on the low end from 2, 3, 4, or to 5 on the high end to 3, 4, 5, 10 or more. In even other embodiments, N may be 2, 3, 4, 5, 10, or more, with the upper limit on N only limited by technology.

MOSFETs are well known for their use in power regulators. The present disclosure is not intended to be limited to any particular type of MOSFET. Rather, the MOSFETs will be selected for the particular design criteria as it relates to the ultimate end use of power regulator 100. Thus, it is believed that one of ordinary skill in the art will be able to select an appropriate MOSFET for incorporation into the power regulators of this disclosure.

In some non-limiting embodiments, the power regulator of the present invention may include only MOSFETs having the same gate-charge (Qg). In other non-limiting embodiments, the power regulator of the present invention may include MOSFETs having with different Qg values. In certain non-limiting embodiments, the MOSFETs can then be separately controlled and used independently as loads change during operation,

Power regulator 100 may also include inductor 25. In a switched-mode power supply, an inductor may be used as the energy storage device. During operation of the power regulator, the inductor is energized for a specific on-time, and de-energized for a specific off-time. This ratio between on-time and off-time determines the ratio between input-voltage and output-voltage ratio.

The present disclosure is not intended to be limited to any particular type of inductor. Rather, an inductor will be selected for the particular design criteria as it relates to the ultimate end use of power regulator 100. Thus, it is believed that one of ordinary skill in the art will be able to select an appropriate inductor for incorporation into the power regulators of this disclosure.

According to this disclosure, power regulator 100 may also include a low-side switch 29. This low-side switch 29 may also be a MOSFET, diode or a MOSFET and diode combination. This MOSFET low-side switch 29 may function as a switch to provide inductor 25 a continuous path to maintain load current.

In the practice of this disclosure, high-side switch 20 and MOSFET low-side switch 29 may be operated 180 degrees out of phase, meaning, when high-side switch 20 is on and allowing current flow, MOSFET ground 29 is off and not allowing current flow. Alternatively, when high-side switch 20 is off and not allowing current flow, MOSFET ground 29 is on to ground 31.

As used herein, there may be two operating states for a MOSFET, “enabled” meaning that it may be turned “on” or “off,” and “disabled” meaning that it is off and may not be turned on. When a MOSFET, high-side switch, or switch is “on,” it is allowing current flow, and when “off” or “disabled” it is not allowing current flow. Again, note that when a MOSFET is “enabled,” it may be “on” and allowing current flow, or it may be “off”; and not allowing current flow. It should be understood, when high-side switch 20 is in a disabled/off state and not allowing current flow, all of the parallel branches of circuit 20 must be disabled/off and not allowing current flow. Thus for high-side switch 20 to be in a disabled/off state, all MOSFETs in each parallel branch of circuit 20 are disabled/off. In contrast, for high-side switch 20 to be in an on state and allow current flow, it is only necessary that at least one of the parallel branches of circuit 20 be on, that is, at least one MOSFET be on.

Further according to this disclosures power regulator 100 may also include controller 50 having logic for controlling high-side switch 20 and MOSFET low-side switch 29 in disabled and enabled states, and when in an enabled state, controlling them in an off or on state. This logic may be implemented using hardware, software, firmware, or any combination thereof. Controller 50 may be in communication with and control the N MOSFETS, which in the non-limiting embodiment shown are MOSFETs 21 and 22. Controller 50 may also be in communication with and control low-side switch 29. Controller 50 comprises logic for independently controlling the MOSFETs of switch 20 in an enabled or disabled state, that is, operating some of the MOSFETs enabled while simultaneously operating the remaining MOSFETs disabled. In order to charge inductor 25, switch 20 is enabled and cycled between on and off states, by cycling the MOSFETs between on and off states. However, it should be understood, that cycling is only applied to MOSFETs in switch 20 which are enabled, and not to MOSFETs in switch 20 which have been disabled. In the practice of this disclosure, high-side switch 20 MOSFETs which are in a disabled mode are not cycled between on and off during switching until they are operated in an enabled mode. Those MOSFETs in an enabled mode are the ones cycled between on and off.

In certain non-limiting embodiments, controller 50 includes logic for independently controlling at least one of the N MOSFETs enabled, while simultaneously controlling the remaining MOSFETs disabled. By “remaining” it is meant the N MOSFETs less than the at least one “enabled” MOSFETs. Another example, for MOSFETs 21 and 22, includes enabling one of them while simultaneously disabling the other one.

For a non-limiting embodiment in which high-side switch 20 has N MOSFETs arranged in parallel, controller 50 may comprise logic for turning all MOSFETs in circuit 20 enabled, all MOSFETS in circuit 20 disabled, or as long as the MOSFETS are similar, some enabled and some disabled.

Controller 50 may also receive feedback to operating high-side switch 20 and low-side switch 29 to provide the desired output 28. Non-limiting examples of feedback include, by are not limited to, feedback relating to current (i_{L}(t)) flowing through inductor 254 feedback relating to voltage of output 28 of inductor 25, thermal related feed back, and/or operational feedback. In one non-limiting embodiment controller 50 receives feed back relating to current (i_{L}(t)) flowing thru inductor 25. In another non-limiting embodiment, controller 50 receives, feedback relating to voltage of output 28.

It is noted that the gate-charge (Qg) of a MOSFET is a large contributing factor for any losses incurred. Controller 50 may include logic to select MOSFETs based on their respective Qg values. Controller 50 may also include logic to select MOSFETs to operate in an enabled state and to select MOSFETs to operate in a disabled state based on the Qg values of the various MOSFETs. Controller 50 includes control of HS and LS fets. There is no point in time where the HS and LS fets are turned on simulataneously.

As a non-limiting example, in a two MOSFET design of MOSFETs having different Qg values, in a low mode (i.e., low load) situation, the MOSFET with the lower Qg can be enabled (with the other disabled), in a higher mode (i.e., higher load) situation the MOSFET with the higher Qg can be enabled (with the other disabled), and in an even higher mode situation both MOSFETs may be enabled. Certainly, one of ordinary skill in the art recognizes that use of MOSFETs in parallel generally requires MOSFET's having same or similar Qg values.

As another non-limiting example, in an N MOSFET design having MOSFETs with various Qg values, controller 50 may be provided with logic for selecting a first portion of the N MOSFETs (with same first Qg values) to enable, and for selecting a remaining portion of the N MOSFETS (with same second Qg values) to disable. Note that what constitutes a given mode or load level (i.e., “low,” “light” or “heavy”) is dependent upon parameters set by the user and the design of the regulator, and this disclosure is not limited to any particular value for a load or mode level.

Controller 50 may also include logic to independently vary the operating state of each MOSFET in high-side switch 20 during operation of power regulator 100. In some embodiments, this logic may make operational decisions independent of any feedback, perhaps as non-limiting examples, based on timing or a prearranged order of operation. In other embodiments, this logic may make operational decisions based on feedback. The present disclosure is not limited to any particular feedback, but rather, the type of feedback of interest will be determined by the end user or designer of the regulator.

This logic to independently control each MOSFET may include one controller in communication with all of the MOSFETs, a number of controllers in communication with one or more of the MOSFETS and collectively in communication with them all, or a separate controller for each MOSFET. Specific drivers may be incorporated in one controller and may be distributed among a number of controllers. A controller may refer to a single controller or more than one controller acting together. In one example as shown, MOSFET 21 is in communication with and controlled by driver 51, and MOSFET 22 is in communication with and controlled by driver 52. While driver 51 and 52 are shown in the same controller 50, it is understood that the drivers may be in separate controllers.

As another non-limiting example, in a normal/heavy mode of operation both MOSFETs 21 and 22 are enabled. When feedback indicates the output load 28 of power regulator 100 decreases during a light-load operation, separate drivers 51 and 52 are used to individually control each of MOSFETs 21 and 22, respectively. In the a light-load mode, one of MOSFETs 21 and 22 is disabled through its own driver control 51 or 52, so that losses only incur in MOSFET that is being cycled between on/off in an enabled state to support the power regulator 100. In an actual example, measured efficiencies between a single MOSFET operation and a dual MOSFET operation produced an improvement of 2%. Certainly, this varies depending on load current, the input voltage level, the voltage level used to power the drivers, and the characteristics of the MOSFETs used. However what does not change is when a low load is encountered, the single MOSFET operation shows a greater efficiency when compared to a dual MOSFET operation, translating back to less power dissipation and thus extending battery life.

In the practice of the present disclosure, the point of light-load can be determined any number of ways. The present disclosure is not directed to or limited to any particular manner of determining a light load mode of operation. As examples, this light load mode can be determined in several ways. One non-limiting example includes monitoring the zero-crossing of the current (iL) in the inductor 25.

In a non-limiting description of the operation of power regulator 100, high-side switch 20 is cycled by controller 50 between on and off states. This cycling switches the load current from input power source rail 12 rapidly on and off, causing a charging and discharging of inductor 25 at the cycling frequency, in order to stabilize output 28. This cycling is accomplished by controlling MOSFET's 21 and 22, either they are both enabled and turned on/off together, or one is disabled and thus off constantly while the other is enabled and cycled between on/off. Controller 50 thru driver 59, operates low-side switch 29 180 degrees out of phase with high-side switch 20. When high-side switch 20 is on inductor 25 is charging and tow-side switch 29 is off allowing current from the high side switch. When high-side switch 20 is off, low-side switch 29 is on creating a path to ground 31 and thus discharging inductor 29.

Feedback regarding inductor 25 current or output is used to adjust the cycling frequency, and to determine whether or not to operate one or both of MOSFETS 21 and 22 in the enabled or disabled mode. Upon a variance in the output, feedback to controller 50 serves to alert controller 50 to adjust the cycling frequency. Upon feedback indicating a light load, driver 50 will, thru drivers 51 and 52, operate one of MOSFETs 21 and 22 into a disabled state, and simultaneously operate the other of MOSFETs 21 and 22 into an enabled state, to be cycled between an on/off at the cycling frequency. Upon feedback indicating a heavy load, driver 50 will, thru drivers 51 and 52 operate both of MOSFETs 21 and 22 into an enabled state, to be cycled between an on/off state at the cycling frequency.

In embodiments having more than two MOSFETs in high-side switch 20, driver 50 will upon feedback indicating a light load, operate at least one of MOSFETs into a disabled state, and simultaneously enable the other MOSFETs, to be cycled between on/off at the cycling frequency. Upon feedback indicating a heavy load, driver 50 may operate all of the MOSFETs into an enabled state, increase the number of MOSFETs in an enabled state, or keep the same number of MOSFETs enabled but select a different set of the same number with Qg values appropriate for the heavy load.

It should be understood, that any or all of power regulator 100 may be considered to be an IHS, or may form part or all of an IHS. In some embodiments, power regulator 100 is incorporated into and forms part of an IHS. In other embodiments, power regulator 100 may be a stand along unit and may be considered an IHS.

In further non-limiting embodiments one or more or all of the steps of any of the methods described herein may be described as instructions for execution by an information handling system, and stored on one or more computer readable medium or transmitted by a propagated signal.

Portions of the present disclosure, detailed description and claims may be presented in terms of software or software implemented aspects typically encoded on a variety of media including, but not limited to, computer-readable media, machine-readable media, program storage media or computer program product. Such media may be handled, read, sensed and/or interpreted by an information handling system (IHS). Those skilled in the art will appreciate that such media may take various forms such as cards, tapes, magnetic disks (e.g., floppy disk or hard drive) and optical disks (e.g., compact disk read only memory (“CD-ROM”) or digital versatile disc (“DVD”)). It should be understood that the given implementations are illustrative only and shall not limit the present disclosure.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below,

1. A power regulator comprising:
A high-side switch comprising a first MOSFET and a second MOSFET in parallel;
An inductor;
An electrical pathway between the high-side switch and the inductor;
A controller communicatively coupled to the high-side switch, the controller comprising logic to:
operate the high-side switch by simultaneously enabling the first MOSFET and disabling the second MOSFET; and
receive feedback indicating a load increase, and upon such feedback will change the high-side switch from a light operational mode in which the first MOSFET is enabled and the second MOSFET is disabled, to a heavy operational mode in which both the first and second MOSFETs are enabled.

2. The power regulator of claim 1, wherein the controller further comprises logic to operate the high-side switch by simultaneously enabling the first MOSFET based on a gate charge (Qg) value of the first MOSFET, and disabling the second MOSFET based on the gate charge (Qg) value of the second MOSFET.

3. The power regulator of claim 1, wherein the controller further comprises logic to receive feedback indicating a light load, and upon such feedback will operate the high-side switch by simultaneously enabling the first MOSFET, and disabling the second MOSFET.

4. (canceled)

5. The power regulator of claim 1, wherein the controller further comprises logic to receive feedback indicating a load decrease, and upon such feedback will change the high-side switch from a heavy operational mode in which the first and second MOSFETs are enabled, to a light operational mode in which the first MOSFET is enabled and the second MOSFET is disabled.

6. The power regulator of claim 1, wherein the controller comprises a first driver for controlling the first MOSFET, and a second driver for controlling the second MOSFET.

7. The power regulator of claim 6, wherein each of the first and second drivers generate a plurality of signals.

8. A method of regulating current flowing through an electrical pathway between a high-side switch and an inductor, wherein the high-side switch comprises a first MOSFET and a second MOSFET in parallel, the method comprising:
operating the high-side switch by simultaneously enabling the first MOSFET and disabling the second MOSFET;
receiving feedback indicating a load increase: and
changing the switching circuit from a light operational mode in which the first MOSFET is enabled and the second MOSFET is disabled, to a heavy operational mode in which both the first and second MOSFETs are enabled.

9. The method of claim 8, wherein the operating step is carried out by simultaneously enabling the first MOSFET based on a gate charge value of the first MOSFET, and disabling the second MOSFET based on the gate charge value of the second MOSFET.

10. The method of claim 8, further comprising:
receiving feedback indicating a light load;
operating the high-side switch by simultaneously enabling the first MOSFET and disabling the second MOSFET.

11. (canceled)

12. The method of claim 8, further comprising:
receiving feedback indicating a load decrease;
changing the high-side switch from a heavy operational mode in which the first and second MOSFETs are enabled, to a light operational mode in which the first MOSFET is enabled and the second MOSFET is disabled.

13. The method of claim 8, wherein the operating step is carried out with a first driver for operating the first MOSFET, and a second driver for operating the second MOSFET.

14. The method of claim 13, wherein the first and second drivers generate a plurality of signals.

15. A computer-readable medium having stored thereon executable instructions for performing a method for regulating current flowing through an electrical pathway between a high-side switch and an inductor, wherein the high-side switch comprises a first MOSFET and a second MOSFET in parallel, the medium comprising:
at least one instruction for operating the high-side switch by simultaneously enabling the first MOSFET and disabling the second MOSFET;
at least one instruction for receiving feedback indicating a load increase: and,
at least one instruction for changing the switching circuit from a light operational mode in which the first MOSFET is enabled and the second MOSFET is disabled, to a heavy operational mode in which both the first and second MOSFETs are enabled.

16. The computer-readable medium of claim 15, wherein the instruction for the operating step is carried out by simultaneously enabling the first MOSFET based on a gate charge (Qg) value of the first MOSFET, and disabling the second MOSFET based on the gate charge (Qg) value of the second MOSFET.

17. The computer-readable medium of claim 15, further comprising:
at least one instruction for receiving feedback indicating a light load; and
at least one instruction for operating the high-side switch by simultaneously enabling the first MOSFET enabled and disabling the second MOSFET.

18. (canceled)

19. The computer readable medium of claim 15, further comprising:
at least one instruction for receiving feedback indicating a load decrease; and,
at least one instruction for changing the high-side switch from a heavy operational mode in which the first and second MOSFETs are enabled, to a light operational mode in which the first MOSFET is enabled and the second MOSFET is disabled.

20. The computer readable medium of claim 15, wherein the instruction for the operating step is carried out with a first driver for operating the first MOSFET, and a second driver for operating the second MOSFET.
